(19) United States
(12) Patent Application Publication
(10) Pub. No.: US 2025/0105971 A1
(43) Pub. Date: Mar. 27, 2025

(54) MOBILE TERMINAL AND METHOD OF TRANSMITTING CHANNEL STATE INFORMATION THROUGH THE MOBILE TERMINAL

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Young Gul WON, Suwon-si (KR); Yunseo NAM, Seoul (KR); Jihoon MOON, Seoul (KR); Byonghyo SHIM, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 18/680,748

(22) Filed: May 31, 2024

(30) Foreign Application Priority Data
Sep. 21, 2023 (KR) 10-2023-0126223

(51) Int. Cl. H04L 5/00; H04L 41/16

(52) U.S. Cl. CPC H04L 5/0051; H04L 41/16

(57) ABSTRACT

There is provided mobile terminal including a receiver configured to receive a pilot signal from a base station at a first time interval, a processor configured to predict a channel based on the received pilot signal by using a neural network at a second time interval shorter than the first time interval, and to determine channel state information based on the predicted channel, and a transmitter configured to provide the determined channel state information to the base station.

### CROSS-REFERENCE TO RELATED APPLICATION(S)

This application is based on and claims priority from Korean Patent Application No. 10-2023-0126223, filed on Sep. 21, 2023, in the Korean Intellectual Property Office, the entire disclosure of which is incorporated herein by reference for all purposes.

### BACKGROUND

### 1. Field

The disclosure relates to an apparatus and a method for data transmission, and in particular, an apparatus and a method of transmitting channel state information.

### 2. Description of the Related Art

Fifth-generation (5G) New Radio (NR) utilizes higher frequency bands than fourth-generation (4G) wireless communication systems, which leads to high path loss. Moreover, 5G NR may be affected by the environment, such as precipitation, atmospheric characteristics, etc. As such, beamforming technology may be used increase signal strength by focusing power in specific directions to transmit power to a receiving end.

According to an embodiment, in order to accurately identify a beam direction, it is important to accurately transmit wireless channel information between a base station and a terminal.

However, due to the mobility of the terminal, a channel during channel estimation by the terminal is inevitably different from a channel during data transmission from the base station, such that, in a case in which data is transmitted and received without considering the channel change, data transfer rates may not be maximized.

### SUMMARY

According to an aspect of the disclosure, there is provide a terminal including: a receiver configured to receive a pilot signal from a base station at a plurality of times, the plurality of times having a first time interval; a processor configured to: predict a channel corresponding to a second time interval based on the pilot signal by using a neural network, the second time interval being shorter than the first time interval, and obtain channel state information based on the predicted channel; and a transmitter configured to provide the channel state information to the base station.

The pilot signal may be a channel state information reference signal (CSI-RS).

The neural network may be configured to: receive the CSI-RS as an input, and output the predicted channel based on the CSI-RS.

The neural network may include: a coarse transformer layer configured to: learn one or more channel parameters of the CSI-RS, received at the first time interval, predict a first channel parameter, among the one or more channel parameters, to be changed, and a fine transformer layer configured to interpolate the first channel parameter at the second time interval.

The one or more channel parameters may include at least one of a direction of a receive path of electromagnetic waves with respect to time in the CSI-RS, an angle of the receive path of the electromagnetic waves, a time of receiving the electromagnetic waves, and an intensity of the electromagnetic waves.

The neural network may include an input layer configured to receive the CSI-RS; a pre-processing layer configured to convert the CSI-RS into data for the coarse transformer layer; a determination layer configured to determine the predicted channel corresponding to the first channel parameter interpolated by the fine transformer layer at the second time interval; and an output layer configured to output the predicted channel.

The determination layer may be configured to: predict an interference pattern of the electromagnetic waves according to the receive path of the electromagnetic waves output by the fine transformer layer, and determine the predicted channel by using the interference pattern.

The channel state information may include at least one of precoding matrix indicator (PMI), rank indicator (RI), or channel quality indicator (CQI).

The processor may be configured to: obtain a plurality of data transfer rates at each prediction time of each of a plurality of predicted channels, and obtain precoding matrix indicator (PMI) information, which maximizes an average value of the obtained plurality of data transfer rates, as the channel state information, wherein the transmitter is configured to provide the PMI information to the base station.

The processor may be configured to obtain precoding matrix indicator (PMI) information, which maximizes data transfer rates at each prediction time of each of a plurality of predicted channels, as the channel state information, wherein the transmitter is configured to provide at least one piece of the PMI information to the base station.

According to another aspect of the disclosure, there is provided a method of data transmission by a terminal, the method including: receiving a pilot signal from a base station at a plurality of times, the plurality of times having a first time interval; predicting a channel corresponding to a second time interval based on the pilot signal by using a neural network, the second time interval being shorter than the first time interval; obtaining channel state information based on the predicted channel; and providing the channel state information to the base station.

According to another aspect of the disclosure, there is provided a terminal including: a receiver configured to receive a pilot signal from a base station at a plurality of times, the plurality of times having a first time interval; a processor configured to output channel state information based on the pilot signal being input into a neural network; and a transmitter configured to provide the output channel state information to the base station.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustrative drawings. Embodiments herein are illustrated by way of examples in the accompanying drawings, and in which:

FIG. 1 is a flowchart illustrating a comparative data transmission and reception process between a base station and a terminal.

FIG. 2 is a block diagram illustrating a mobile terminal for transmitting channel state information according to an embodiment of the disclosure.

FIG. 3 is a block diagram illustrating a neural network structure for channel prediction.

FIG. 4 is a diagram illustrating a timeline of receiving channel state information and predicted channels.

FIG. 5A is a graph showing a relationship between a period of a channel state information reference signal and PMI.

FIG. 5B is a graph showing a relationship between a period of a channel state information reference signal and a data transfer rate.

FIG. 6 is a flowchart illustrating a method of transmitting channel state information by a mobile terminal.

FIG. 7 is a block diagram illustrating a mobile terminal for transmitting channel state information according to another embodiment of the disclosure.

FIG. 8 is a block diagram illustrating a neural network structure in a processor according to an embodiment of the disclosure.

### DETAILED DESCRIPTION

Details of other embodiments are included in the following detailed description and drawings. Advantages and features of the disclosure, and a method of achieving the same will be more clearly understood from the following embodiments described in detail with reference to the accompanying drawings. Throughout the drawings and the detailed description, unless otherwise described, the same drawing reference numerals will be understood to refer to the same elements, features, and structures.

It will be understood that, although the terms “first,” “second,” etc. may be used herein to describe various elements, these elements should not be limited by these terms. These terms are only used to distinguish one element from another. Any references to singular may include plural unless expressly stated otherwise. In addition, unless explicitly described to the contrary, an expression such as “comprising” or “including” will be understood to imply the inclusion of stated elements but not the exclusion of any other elements.

Embodiments herein may be described and illustrated in terms of blocks which carry out a described function or functions. These blocks, which may be referred to herein as units, modules, or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. However, the disclosure is not limited thereto, and as such, the blocks, which may be referred to herein as units, modules, or the like, may be software modules implemented by software codes, program codes, software instructions, or the like. The software blocks may be executed on one or more processors. According to an embodiment, the terms, such as “block”, “unit” or “module,” etc., should be understood as a unit that performs at least one function or operation and that may be embodied as hardware, software, or a combination thereof.

Expressions, such as “at least one of,” for example, the expression, “at least one of a, b, and c,” should be construed as including only a, only b, only c, both a and b, both a and c, both b and c, or all of a, b, and c.

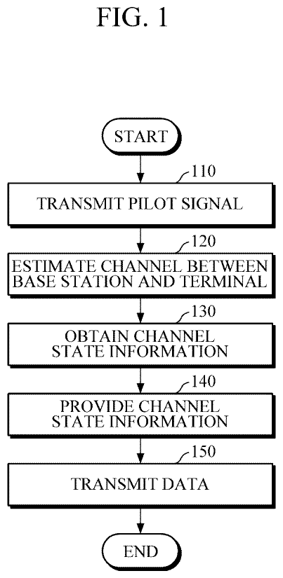

FIG. 1 is a flowchart illustrating a comparative data transmission and reception process between a base station and a terminal. The terminal may be a mobile terminal.

Referring to FIG. 1, in operation 110, the base station may transmit a pilot signal to a terminal. The pilot signal may be a signal known to both the base station and the terminal. In operation 120, the terminal may estimate a channel between the base station and the terminal based on the pilot signal. In operation 130, the terminal may obtain channel state information (CSI) for downlink data transmission from the base station. For example, the terminal may determine the CSI based on the estimated channel between the base station and the terminal. Subsequently, in operation 140, the terminal may provide the obtained determined channel state information to the base station. Here, the terminal may provide the obtained determined channel state information to the base station as a feedback. In operation 150, the base station may determine beam information and modulation and coding scheme (MCS) information based on the provided channel state information and transmit data to the terminal.

The comparative data transmission and reception process between the base station and the terminal illustrated in FIG. 1 has a limitation in that channel state information at a time when the terminal receives the pilot signal is fed back. For example, while the terminal estimates and obtains information optimal for a channel at the time of receiving the pilot signal and feeds back the optimal information to the base station, the terminal does not consider a channel change during a period of actual downlink transmission. As such, the base station may not transmit data using the optimal beam and modulation and coding scheme over the entire downlink transmission time.

In other words, due to the mobility of the terminal, a channel obtained during channel estimation at a time when the terminal receives the pilot signal is likely to be different from a channel during data transmission from the base station (channel aging effect), such that when the terminal generates channel state information without considering the channel change and feeds back the information to the base station, and when the base station transmits data based on the fed-back information, it may be difficult to maximize data transfer rates.

Further, in frequency division duplex (FDD) system, channel state information may be fed back periodically or aperiodically in consideration of the mobility of the terminal, such that, in case of short intervals between the pilot signals, frequency efficiency may decrease due to frequent transmission of the pilot signals, and in case of long intervals between the pilot signals, a downlink transmission rate may decrease due to the channel aging effect.

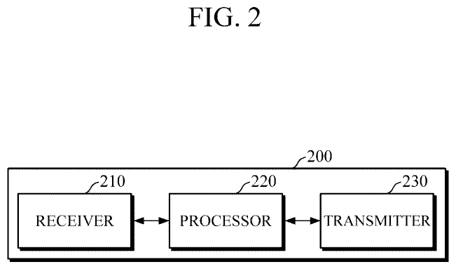

FIG. 2 is a block diagram illustrating a terminal for transmitting channel state information according to an embodiment of the disclosure. According to an embodiment, the terminal may be a mobile terminal.

Referring to FIG. 2, a mobile terminal 200 includes a receiver 210, a processor 220, and a transmitter 230.

The receiver 210 may receive a pilot signal transmitted from a base station. According to an embodiment, the mobile terminal may receive the pilot signal at a first time interval. For example, the pilot signal may be transmitted a plurality of times, and an interval between each of the plurality of times the pilot signal is transmitted is the first time interval. For example, the first time interface may be 80 ms, but the disclosure is not limited thereto. In a case in which the first time interface is 80 ms, the mobile terminal may receive the pilot signal every 80 ms.

In a frequency division duplex (FDD) system, the pilot signal transmitted from the base station may be, for example, a channel state information reference signal (CSI-RS). The channel state information is information indicating a channel state. For example, the channel state information may include, but is not limited to, precoding matrix indicator (PMI), rank indicator (RI), channel quality indicator (CQI), etc., The CSI-RS may be a reference signal for feeding back channel state information to the base station. For example, the CSI-RS may include, but is not limited to a reference signal with various configurations, such as antenna ports, density, periodic/aperiodic state, and the like. However, the disclosure is not limited thereto, and as such, the pilot signal may be a signal different than CSI-RS.

The processor 220 may determine channel state information based on the received pilot signal.

According to an embodiment, the processor 220 may predict channels corresponding to a reference time interval by using a neural network. For example, the reference time interval may be predetermined time interval. For example, the reference time interval may be a second time interval shorter than the first time interval based on the received pilot signal. The second time interval may be 20 ms, but the disclosure is not limited thereto. According to an embodiment, the predetermined time interval may be the second time interval (e.g., 20 ms) shorter than the first time interval, and by using a neural network, the processor 220 may predict a channel at a time of the pilot signal is received and one or more channels corresponding to one or more subsequent times after the time at which the pilot signal is received.

The processor 220 according to one or more embodiments may perform an overall control operation of the mobile terminal 200.

The processor 220 may include at least one from among a central processing unit (CPU), a graphics processing unit (GPU), an accelerated processing unit (APU), a many integrated core (MIC), a digital signal processor (DSP), a neural processing unit (NPU), an hardware accelerator or a machine learning accelerator. The processor 220 may execute at least one program or instruction stored in a memory. For example, the processor 220 may perform a method according to one or more embodiments by executing at least one instruction stored in the memory.

According to one or more embodiments of the disclosure, one or more operations may be performed by one processor, or performed by a plurality of processors. For example, when a first operation, a second operation, and a third operation are performed by the method according to one or more embodiments, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor). According to an embodiment, at least one of the first, second and third processor may be external to the terminal 200.

The processor 220 may be realized as a single core processor that includes one core, or may be realized as at least one multicore processor that includes a plurality of cores (e.g., a homogeneous multicore or a heterogeneous multicore). In a case in which the processor 220 is realized as a multicore processor, the plurality of cores included in the multicore processor may respectively include a memory inside the processor such as a cache memory and an on-chip memory, and a common cache shared by the plurality of cores may be included in the multicore processor.

According to one or more embodiments of the disclosure, the processor may refer to a system on chip (SoC), a single core processor, a multicore processor, or a core included in the single core processor or the multicore processor on which at least one processor and other electronic components are integrated, and the core described herein may be realized as the CPU, the GPU, the APU, the MIC, the DSP, the NPU, the hardware accelerator, the machine learning accelerator, or the like, but the embodiments of the disclosure are not limited thereto.

According to an embodiment, the mobile terminal 200 may include a memory. According to an example, the memory may store data necessary for the various embodiments of the disclosure. The memory may be realized in a memory form embedded to the mobile terminal 200 according to data storage use, or realized in a memory form which is attachable to or detachable from the mobile terminal 200.

The memory may be realized as at least one from among a volatile memory (e.g., a dynamic random access memory (DRAM), a static RAM (SRAM), or a synchronous dynamic RAM (SDRAM)), or a non-volatile memory (e.g., one time programmable read only memory (OTPROM), programmable ROM (PROM), erasable and programmable ROM (EPROM), electrically erasable and programmable ROM (EEPROM), mask ROM, flash ROM, a flash memory (e.g., NAND flash or NOR flash), a hard disk drive (HDD) or a solid state drive (SSD)). In addition, the memory may be realized in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, and the like.

According to an example, the memory 130 may store at least one instruction or a computer program including instructions for controlling the mobile terminal 200.

According to an embodiment, the neural network may be a network structure containing a plurality of layers that use the received CSI-RS as input and the predicted channels as output. According to an embodiment, the neural network may be implemented by one or more processors. According to an embodiment, the one or more processor may include the processor 220. According to an embodiment, the one or more processor may include one or more processors external to the mobile terminal 200.

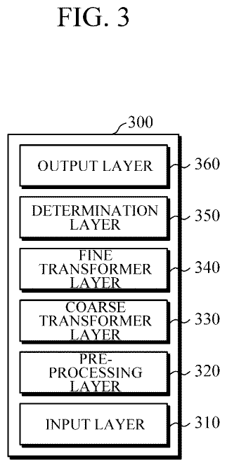

FIG. 3 is a block diagram illustrating a neural network structure for channel prediction.

Referring to FIG. 3, a neural network 300 may include an input layer 310, a pre-processing layer 320, a coarse transformer layer 330, a fine transformer layer 340, a determination layer 350, and an output layer 360. However, the neural network structure is not limited to the illustration in FIG. 3, and as such, according to another embodiment, the neural network layer 300 may be modified into various structures by omitting, adding layers, or combining or more layers, and the like.

The input layer 310 may receive a CSI-RS. The CSI-RS maybe transmitted from a base station.

The pre-processing layer 320 may perform a preprocessing operation on the CSI-RS. For example, the pre-processing layer 320 may perform preprocessing for converting the received CSI-RS into data suitable for the next layer (e.g., coarse layer 330). For example, the pre-processing layer 320 may perform preprocessing for converting the received CSI-RS into data which may be learned in the subsequent coarse transformer layer 330.

The coarse transformer layer 330 may learn channel parameters of the CSI-RS received at a first time interval, to predict a channel parameter to be changed. According to an embodiment, the channel parameters may include a direction of a receive path of first electromagnetic waves with respect to the time in the CSI-RS, an angle of the receive path of the first electromagnetic waves, a time of receiving the first electromagnetic waves, an intensity of the first electromagnetic waves, and the like. The first electromagnetic waves may be referred to as main or primary electromagnetic waves. For example, the first electromagnetic waves may include, but is not limited to, line-of-sight electromagnetic waves and/or dominant non-line-of-sight electromagnetic waves.

For example, by learning the direction and angle of the receive path of the first electromagnetic waves in the CSI-RS received at the time interval, the coarse transformer layer 330 may predict the direction and angle of the receive path of electromagnetic waves at a time of actually receiving a CSI-RS and electromagnetic waves at subsequent times (e.g., times subsequent to the time the CSI-RS was received at the mobile terminal).

The fine transformer layer 340 may interpolate the predicted channel parameters at a second time interval. For example, the second time interval may be shorter than the first time interval at which the CSI-RS is received.

The channel parameters, predicted by the coarse transformer layer 330, may be channel parameters predicted at the first time interval (e.g., 80 ms) at which the CSI-RS is received, and the fine transformer layer 340 may learn the parameters predicted by the coarse transformer layer 330 at the first time interval (e.g., 80 ms), and may output channel parameters at the second time interval (e.g., 20 ms) shorter than the first time interval.

The determination layer 350 may determine a predicted channel corresponding to the predicted channel parameter interpolated by the fine transformer layer 340 at a relatively short time interval. For example, the determination layer 350 may predict a constructive or destructive interference pattern of electromagnetic waves according to the direction and angle of the receive path of the electromagnetic waves which are channel parameters output by the fine transformer layer 340, and may determine a predicted channel by using the predicted constructive or destructive interference pattern.

The output layer 360 may output the determined predicted channel. According to an embodiment, the processor 220 may obtain the channel state information based on the predicted channel.

According to an embodiment, the transmitter 230 may provide the channel state information to the base station. For example, the transmitter 230 may feedback the determined channel state information to the base station.

The channel state information determined by the processor 220 may be at least one of PMI, RI, and CQI, but is not limited thereto. The PMI is information for determining a code of a beamforming codebook for use in beamforming, the RI is information indicating the rank of a channel, and the CQI is an amount of information that can be transmitted through a current channel. The following description will be given using PMI as an example.

The processor 220 may determine a statistical value (e.g., average value) of pieces of PMI information, which may be obtained at each prediction time of each predicted channel, as final PMI information, and may feedback the determined final PMI information to the base station.

For example, the processor 220 may obtain data transfer rates at each prediction time of each predicted channel, and may determine PMI information, which maximizes an average value of the obtained plurality of data transfer rates, as channel state information and may feedback the determined channel state information to the base station.

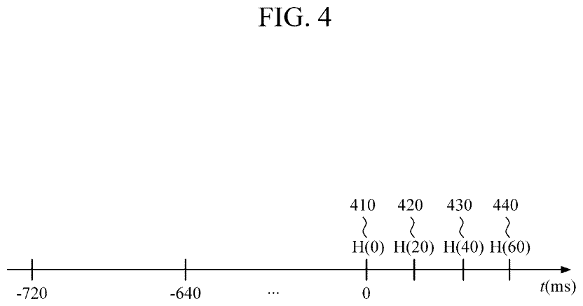

FIG. 4 is a diagram illustrating a timeline of receiving channel state information and predicted channels.

Referring to FIG. 4, the mobile terminal may receive channel state information reference signals at times −720 ms, −640 ms, . . . , and 0 ms at an interval of, for example, 80 ms, and may output predicted channels 410, 420, 430, and 440 at times 0 ms, 20 ms, 40 ms, and 60 ms at an interval of, for example, 20 ms by using a neural network.

According to an embodiment, the processor 220 may obtain data transfer rates which may be obtained at the respective prediction times 0 ms, 20 ms, 40 ms, and 60 ms of the respective predicted channels 410, 420, 430, and 440, and may determine PMI information, which maximizes an average value of the data transfer rates, as channel state information.

The PMI information (W_{T}) that maximizes an average value of the data transfer rates may be represented by the following Equation 1.

$${W}_{T} = {arg max}_{W ∈ C} {\sum }_{t = {t}_{s}}^{{t}_{e}} {\sum }_{f = {f}_{s}}^{{f}_{e}} {log}_{2} ( 1 + \frac{{‖ {W}^{T} H ( f , t ) ‖}^{2}}{{σ}^{2}} ) \qquad [ Equation 1 ]$$

Herein, C denotes a codebook which is a set of beamforming vectors, f denotes frequency, t denotes time, W denotes PMI information at each predicted channel, H denotes the predicted channel, W^{T}H denotes a matrix multiplication of the PMI information and channels, σ² denotes a signal-to-noise ratio, tₛ and tₑ denote a start time and an end time of each predicted channel, fₛ and fₑ denote a frequency at the start time and a frequency at the end time of each predicted channel, and

$${W}_{T} = {arg max}_{W ∈ C} {\sum }_{t = {t}_{s}}^{{t}_{e}} {\sum }_{f = {f}_{s}}^{{f}_{e}} {log}_{2} ( 1 + \frac{{‖ {W}^{T} H ( f , t ) ‖}^{2}}{{σ}^{2}} ) \qquad [ Equation 1 ]$$

denotes an index return function and a function for finding the PMI information WT, which maximizes an average value of the data transfer rates, in the codebook.

In addition, the processor 220 may also determine each PMI information, which maximizes the data transfer rate at each prediction time of each predicted channel, as channel state information.

Referring to FIG. 4, the processor 220 may determine each PMI information which maximizes the data transfer rate at the respective prediction times 0 ms, 20 ms, 40 ms, and 60 ms of the respective predicted channels 410, 420, 430, and 440. According to an embodiment, the transmitter 230 may feedback at least one piece of the determined PMI information. For example, the transmitter 230 may feedback all the four pieces of PMI information obtained at the respective prediction times, or may feedback only two pieces of PMI information obtained at times 0 ms and 40 ms. The method of feeding back the determined PMI information is not limited thereto.

In a comparative data transmission and reception process between the base station and the terminal, only channel state information at a time when the terminal receives the channel state information reference signal is fed back to the base station, such that a channel change due to the mobility of the terminal is not considered, causing a problem in that a data transfer rate is not maximized.

According to an embodiment in which channel state information is determined by channel prediction using a neural network and is fed back to the base station, channels may be predicted at a shorter time interval than a time interval of receiving the channel state information reference signals according to a predetermined period, thereby considering a channel change due to the mobility of the terminal and correcting a channel aging effect, and a relatively long time interval of receiving the channel state information reference signals may be maintained, thereby reducing overhead costs due to data transmission and reception.

Furthermore, unlike the comparative example, channels may be predicted based on only the channel state information reference signal by using a neural network without direct channel estimation between the base station and the terminal, thereby reducing noise caused by channel estimation, and as a result, increasing data transfer rates.

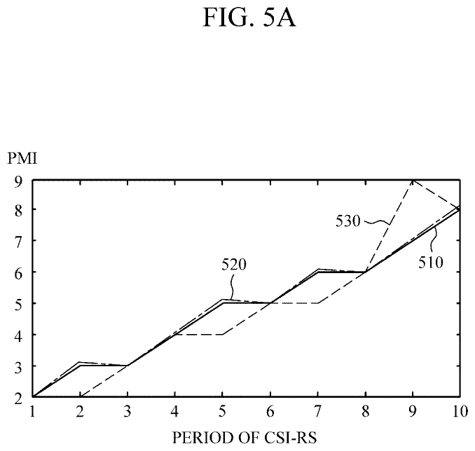

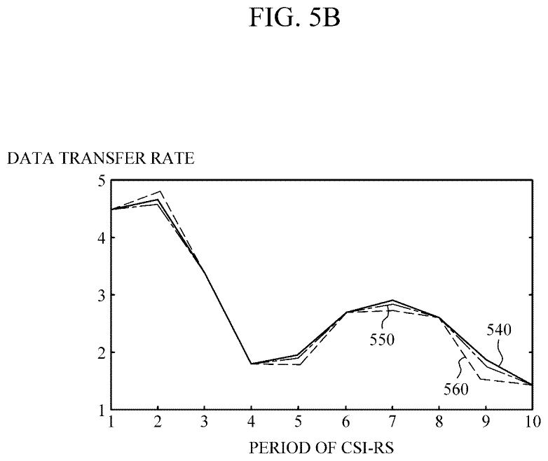

FIG. 5A is a graph showing a relationship between a period of a channel state information reference signal and PMI, and FIG. 5B is a graph showing a relationship between a period of a channel state information reference signal and a data transfer rate. In FIG. 5A, the graph shows a PMI 510, which is the actually measured PMI, a PMI 520, which is determined through channels predicted using the neural network according to one or more embodiments of the disclosure, and a PMI 530, which is measured according to the comparative channel estimation method. In FIG. 5B, the graph shows a data transfer rate 540 based on the actually measured PMI, a data transfer rate 550 based on the PMI determined using the neural network according to one or more embodiments of the disclosure, and a data transfer rate 560 based on the PMI measured by the comparative channel estimation method.

Referring to FIG. 5A, it can be seen that PMI 520, which is determined through channels predicted using a neural network, is more similar to actually measured PMI 510 than PMI 530 measured by the comparative channel estimation method. Referring to FIG. 5B, it can be seen that a data transfer rate 550 based on the PMI determined using a neural network is more similar to a data transfer rate 540 based on the actually measured PMI than a data transfer rate 560 based on the PMI measured by the comparative channel estimation method.

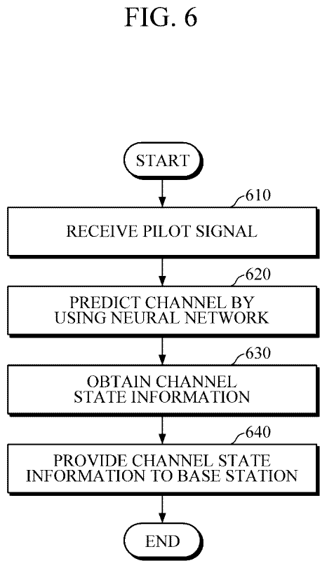

FIG. 6 is a flowchart illustrating a method of transmitting channel state information by a mobile terminal.

FIG. 6 is an example of a method of transmitting channel state information by the mobile terminal according to the embodiments of FIGS. 2 to 4, which are described in detail above, and thus will be briefly described below in order to avoid redundancy.

According to an embodiment, in operation 610, the method may include receiving a pilot signal. For example, the mobile terminal may receive a pilot signal at a first time interval from the base station. The pilot signal may be a channel state information reference signal (CSI-RS).

In operation 620, the method may include predicting a channel based on the pilot signal. For example, the mobile terminal may predict a channel at a second time interval, shorter than the first time interval, based on the received pilot signal by using a neural network in 620.

The neural network may output the channel predicted by using the received CSI-RS as input, and may include a coarse transformer layer, which learns channel parameters of the CSI-RS received at a predetermined time interval to predict a channel parameter to be changed, and a fine transformer layer which interpolates the predicted channel parameter at a second time interval.

According to an embodiment, the channel parameters may include at least one of a direction of a receive path of electromagnetic waves with respect to time in the CSI-RS, an angle of the receive path of the electromagnetic waves, a time of receiving the electromagnetic waves, and an intensity of the electromagnetic waves.

In operation 630, the method may include obtaining channel state information, and in operation 640, the method may include providing the channel state information to the base station. For example, the mobile terminal may determine channel state information based on the predicted channel, and may feedback the determined channel state information to the base station.

The mobile terminal may determine a statistical value (e.g., average value) of pieces of PMI information, which may be obtained at each prediction time of each predicted channel, as final PMI information, and may feedback the determined final PMI information to the base station.

For example, the mobile terminal may obtain data transfer rates at each prediction time of each predicted channel, and may determine PMI information, which maximizes an average value of the obtained plurality of data transfer rates, as channel state information and may feedback the determined channel state information to the base station.

In addition, the mobile terminal may also determine each PMI information, which maximizes the data transfer rate at each prediction time of each predicted channel, as channel state information, and may feedback at least one piece of the determined PMI information to the base station.

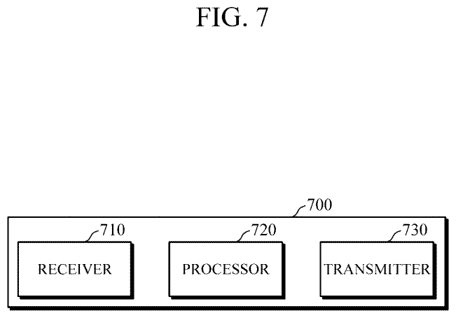

FIG. 7 is a block diagram illustrating a mobile terminal for transmitting channel state information according to another embodiment of the disclosure.

Referring to FIG. 7, a mobile terminal 700 may include a receiver 710, a processor 720, and a transmitter 730.

The receiver 710 may receive a pilot signal transmitted from a base station. The mobile terminal may receive the pilot signal at a first time interval (e.g., 80 ms), and the pilot signal may be a channel state information reference signal (CSI-RS).

The processor 720 may output channel state information by inputting the received pilot signal through a neural network, and the transmitter 730 may feedback the output channel state information to the base station.

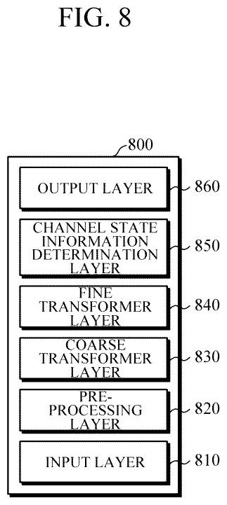

FIG. 8 is a block diagram illustrating a neural network structure in the processor 720 according to an embodiment of the disclosure.

For example, a neural network 800 may include an input layer 810 that receives a CSI-RS, a pre-processing layer 820 that converts the received CSI-RS into data which may be learned in a coarse transformer layer, a coarse transformer layer 830 that learns channel parameters of the CSI-RS received at a first time interval to predict a channel parameter to be changed, a fine transformer layer 840 that interpolates the predicted channel parameter at a second time interval, a channel state information determination layer 850 that determines channel state information by learning the interpolated channel parameter, and an output layer 860 that outputs the determined channel state information. However, the neural network structure is not limited thereto, and may be modified into various structures by omitting or adding layers, and the like.

According to the embodiment of the disclosure, channel state information may be output directly through the neural network without channel estimation or channel prediction, thereby reducing noise caused by channel estimation and channel prediction, and as a result, increasing data transfer rates.

In a time division duplex (TDD) system according to another embodiment of the disclosure, a base station receives a sounding reference signal which is a pilot signal transmitted by a terminal on the uplink, and channel prediction is performed using a neural network based on the received sounding reference signal, and beamforming may also be performed by determining channel state information based on the predicted channel. According to an embodiment, the base station may directly determine channel state information based on the sounding reference signal while omitting the channel prediction performed by the neural network.

One or more embodiment of the disclosure can be realized as a computer-readable code written on a computer-readable recording medium. The computer-readable recording medium may be any type of recording device in which data is stored in a computer-readable manner.

Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that a computer-readable code is written thereto and executed therefrom in a decentralized manner. According to an embodiment, functional programs, codes, and code segments needed for realizing one or more aspects of the disclosure can be readily inferred by programmers of ordinary skill in the art to which the invention pertains.

The disclosure has been described herein with regard to preferred embodiments. However, it will be obvious to those skilled in the art that various changes and modifications can be made without changing technical conception and essential features of the disclosure. Thus, it is clear that the above-described embodiments are illustrative in all aspects and are not intended to limit the disclosure.

What is claimed is:

1. A terminal comprising:
a receiver configured to receive a pilot signal from a base station at a plurality of times, the plurality of times having a first time interval;
a processor configured to:
predict a channel corresponding to a second time interval based on the pilot signal by using a neural network, the second time interval being shorter than the first time interval, and
obtain channel state information based on the predicted channel; and
a transmitter configured to provide the channel state information to the base station.

2. The terminal of claim 1, wherein the pilot signal is a channel state information reference signal (CSI-RS).

3. The terminal of claim 2, wherein the neural network is configured to:
receive the CSI-RS as an input, and
output the predicted channel based on the CSI-RS.

4. The terminal of claim 3, wherein the neural network comprises:
a coarse transformer layer configured to:
learn one or more channel parameters of the CSI-RS, received at the first time interval,
predict a first channel parameter, among the one or more channel parameters, to be changed, and
a fine transformer layer configured to interpolate the first channel parameter at the second time interval.

5. The terminal of claim 4, wherein the one or more channel parameters comprise at least one of a direction of a receive path of electromagnetic waves with respect to time in the CSI-RS, an angle of the receive path of the electromagnetic waves, a time of receiving the electromagnetic waves, and an intensity of the electromagnetic waves.

6. The terminal of claim 4, wherein the neural network comprises:
an input layer configured to receive the CSI-RS;
a pre-processing layer configured to convert the CSI-RS into data for the coarse transformer layer;
a determination layer configured to determine the predicted channel corresponding to the first channel parameter interpolated by the fine transformer layer at the second time interval; and
an output layer configured to output the predicted channel.

7. The terminal of claim 6, wherein the determination layer is configured to:
predict an interference pattern of the electromagnetic waves according to the receive path of the electromagnetic waves output by the fine transformer layer, and
determine the predicted channel by using the interference pattern.

8. The terminal of claim 1, wherein the channel state information comprises at least one of precoding matrix indicator (PMI), rank indicator (RI), or channel quality indicator (CQI).

9. The terminal of claim 1, wherein the processor is configured to:
obtain a plurality of data transfer rates at each prediction time of each of a plurality of predicted channels, and
obtain precoding matrix indicator (PMI) information, which maximizes an average value of the obtained plurality of data transfer rates, as the channel state information,
wherein the transmitter is configured to provide the PMI information to the base station.

10. The terminal of claim 1, wherein the processor is configured to obtain precoding matrix indicator (PMI) information, which maximizes data transfer rates at each prediction time of each of a plurality of predicted channels, as the channel state information,
wherein the transmitter is configured to provide at least one piece of the PMI information to the base station.

11. A method of data transmission by a terminal, the method comprising:
receiving a pilot signal from a base station at a plurality of times, the plurality of times having a first time interval;
predicting a channel corresponding to a second time interval based on the pilot signal by using a neural network, the second time interval being shorter than the first time interval;
obtaining channel state information based on the predicted channel; and
providing the channel state information to the base station.

12. The method of claim 11, wherein the pilot signal is a channel state information reference signal (CSI-RS).

13. The method of claim 12, wherein the predicting of the channel by using the neural network comprises:
receiving the CSI-RS as an input, and
outputting the predicted channel based on the CSI-RS

14. The method of claim 13, further comprising:
learning, by a coarse transformer layer of the neural network, one or more channel parameters of the CSI-RS, received at the first time interval,
predicting, by a coarse transformer layer of the neural network, a first channel parameter, among the one or more channel parameters, to be changed, and
interpolating, by a fine transformer layer of the neural network, the first channel parameter at the second time interval.

15. The method of claim 14, wherein the one or more channel parameters comprise at least one of a direction of a receive path of electromagnetic waves with respect to time in the CSI-RS, an angle of the receive path of the electromagnetic waves, a time of receiving the electromagnetic waves, and an intensity of the electromagnetic waves.

16. The method of claim 11, wherein the determining of the channel state information comprises obtaining a plurality of data transfer rates at each prediction time of each predicted channel, and obtaining precoding matrix indicator (PMI) information, which maximizes an average value of the obtained plurality of data transfer rates, as the channel state information,
wherein the providing of the channel state information to the base station comprises providing the PMI information to the base station.

17. The method of claim 11, wherein the determining of the channel state information comprises obtaining precoding matrix indicator (PMI) information, which maximizes data transfer rates at each prediction time of each of a plurality of predicted channels, as the channel state information,
wherein the providing the channel state information to the base station comprises providing at least one piece of the PMI information to the base station.

18. A terminal comprising:
a receiver configured to receive a pilot signal from a base station at a plurality of times, the plurality of times having a first time interval;
a processor configured to output channel state information based on the pilot signal being input into a neural network; and
a transmitter configured to provide the output channel state information to the base station.

19. The terminal of claim 18, wherein the pilot signal is a channel state information reference signal (CSI-RS).

20. The terminal of claim 19, wherein the neural network comprises:
a coarse transformer layer configured to:
learn one or more channel parameters of the CSI-RS, received at a first time interval, and
predict a channel parameter, among the one or more channel parameters, to be changed, and
a fine transformer layer configured to interpolate the first channel parameter at a second time interval.
